(19) United States
(12) Patent Application Publication
(10) Pub. No.: US 2006/0273219 A1
(43) Pub. Date: Dec. 7, 2006

(54) Preconditioning method for flexible supports

(75) Inventors: George T. McCollough, Penfield, NY (US); Robert L. Walton, Fairport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/144,561

(22) Filed: Jun. 3, 2005

(51) Int. Cl. G03D 13/14

(52) U.S. Cl. 242/899

(57) ABSTRACT

The present invention relates to a method of conditioning a support comprising continuously providing a support, applying an interleaving material to at least one side of the support, wherein the interleaving material produces a continuous gap between the opposite side of the support having applied interleaving material and the side of the support having applied interleaving material when the support is wound, and conditioning the support.

### FIELD OF THE INVENTION

The present invention relates to the use of a permeable edge strip interleaving system for the preconditioning of flexible supports in roll format to avoid or minimize dimensional change to the support due to a change in internal moisture content or temperature in a subsequent operation or operations.

### BACKGROUND OF THE INVENTION

Dimensional change in the flexible support, due to changes in the moisture content of the flexible support material during each manufacturing operation, can be significant and problematic. This is especially true in the roll-to-roll manufacture of coated or printed articles on flexible support, such as electronic displays, where proper alignment of various layers to each other is critical. This is due to the fact that flexible supports, such as polyethylene terephthalate (PET), when cast and wound, have essentially zero moisture content, that is, 0% relative humidity (RH). When stored in normal wound roll form, humidity exchange between the bulk of the web and ambient air is essentially zero and the support remains at essentially zero moisture content while rolled up. In roll format, equilibration to the humidity in the air is prevented as moisture can only enter through the exposed edge of the roll. Water transmission through the edge of the polymeric support proceeds at such a slow rate that it is rarely a practical consideration. Web stored in wound roll format will not change in moisture content significantly over months or perhaps even years of storage.

For many display applications, the flexible support is sputter coated in a vacuum chamber with indium tin oxide (ITO). During this process, the web is unwound, sputter coated and wound all within a sealed chamber under strong vacuum. There is no possibility of moisture entering the already close-to-bone-dry support from manufacturing while under vacuum. Further, subsequent storage in roll format ensures that the flexible support with an ITO coating will retain a very low, essentially zero, internal moisture content.

During flexible roll-to-roll display manufacturing, a series of processing steps occur which can and do result in a gain in internal moisture content of support. The ITO coating can be chemically or laser etched and various layers are coated and printed and applied with techniques that expose the flexible support to humidity in the process air, immersion in aqueous environments and moisture in the coated or printed materials in intimate contact with the support. The flexible support will begin to equilibrate by picking up moisture with a resulting dimensional change.

In most display applications, alignment tolerances are critical. Without a way to precondition the flexible support to a target internal moisture level closer to that of the process than the bone-dry levels encountered with cast flexible supports or sputter coated ITO cast flexible supports, significant dimensional change will occur during each subsequent operation.

In the absence of a method to precondition the support to humidity in roll format, the resulting dimensional change, as the flexible support picks up moisture during each process step, must be carefully managed by accurately timing the exposure of the support to a tightly controlled relative humidity of the process air and accounting for the resulting amount of dimensional change in the next step. This management is very difficult if not impossible to achieve as a practical matter and it would be much better to equilibrate the support to a relative humidity close to or equal to that of the next manufacturing operation so that none or very small dimensional changes due to humidity change would be encountered by the support. The equilibration of the support requires that the surface of the support be exposed to a controlled relative humidity air or soaked in a water bath long enough for the moisture content of the support to equilibrate. Stated values vary, but it appears a bare 4-mil PET web with both sides exposed has a moisture diffusion time constant of about three hours. The moisture diffusion time constant is expected to vary with the square of the sheet thickness, and to be four times as large for single-sided exposure.

ITO is a good moisture barrier. An ITO coating on one side will essentially convert the PET to one-sided moisture exchange. This one-sided moisture exchange will not affect the final equilibrium, but will make the moisture exchange time constant about four times a large.

Coated and printed materials can absorb more moisture than PET, and equilibrate far more quickly. For example, gelatin based coatings will equilibrate to the relative humidity in the process air in 30 seconds to one minute. Once in a roll format, the moisture picked up in the coated or printed layer will slowly equilibrate with the flexible support over time. When the coating is coated on the ITO side of the flexible support, equilibration will occur in roll format through contact of the coating with the back side of the flexible support on the material of the next lap in the roll. The final moisture content will end up at an intermediate relative humidity (RH) between that of the winding environment and that of the incoming PET. The final equilibrium will depend on the thickness of the gel and of the PET.

Every time the exposed coated or printed material is exposed in subsequent operations, it will quickly equilibrate to the relative humidity of the process air. Later, the exposed coated material, in roll form, will expose the support to process conditions over time, thus changing the dimensions of the flexible support while moving closer to full equilibrium with the relative humidity of the process air. For example, an ITO gel based coated material is unwound, printed with PTF inks, UV cured, and wound again. The gel based coating equilibrates to the relative humidity level in the printer area rapidly. However, the printing process occurs too quickly to have much direct moisture exchange with the PET base, and more so since the coating is applied to the ITO coated side of the web. In wound roll form, however, the gel is in contact with the back side of the PET, and moisture exchange will occur with an expected time constant of about 12 hours. When this exchange is complete, the package will be equilibrated to something between 0% and 50%, probably in the range of 20 to 40%, depending on the thickness of the gel, and possibly its composition. The dimensional change of a 20-inch patch over this process (ITO etch to second/subsequent PTF passes) is expected to be (50% RH)*(8e-6 in/in/% RH)*(20 inches)=0.008 inches longer. This will pose a significant concern for precision alignment of sequential process steps with the concern increasing as the size or resolution of the display increases.

Unlike preconditioning for humidity, preconditioning for temperature can occur in a tightly wound roll format given enough time. Temperature changes also result in dimensional changes for flexible polymeric supports. It is known that the ITO layer can deteriorate in-service due to mechanical deformation of the substrate resulting from thermal exposure, as reported in The Effect of Thermal Shrinkage on ITO Coated PET for Flexible Display Applications (by Cairns, SID 01 Digest). The resistance of the ITO layer increases as a result of microscopic cracks in the ITO layer. This cracking is also evident in compression and causes an increase in resistance. Typically the resistance was seen to increase for strains greater than 2%. However, only the dependence of shrinkage and resistance on temperature were investigated. Temperature equilibration of the flexible support in roll format occurs rapidly during conveyance in a processing step, since the support is relatively thin and the surface area for heat exchange high.

US 2002/0176988 describes a protective material and coating applied to temporarily protect a flat or curved support during shipping, handling and transport, that is, the protective material is wound together with the coated roll in laps of alternating coated material and protective material. However, such interleaving does not allow for airflow for humidity preconditioning of the support. Also, the interleaving material is in contact with a coated layer and blocking may occur when the materials are wound together in a roll format.

U.S. Pat. No. 6,653,165 describes the winding of the support of a semiconductor element with a protective material between the roll laps to prevent the production of flaws on the support. The protective material is preferably a paper-like interleaving material, which allows the support to be kept in close fit with the protective material. However such interleaving material may contact the coated layer upon winding, resulting in unacceptable pressure damage to the coating and may cause blocking between the coating and the interleaving paper. Also the interleaving does not allow airflow through the roll, which may be used for humidity preconditioning of the support or to fully cure any layers coated on the support by allowing solvents or gaseous by-products of curing to escape the roll after it has been wound.

U.S. Pat. No. 6,366,013 describes an anti-reflective coating provided on a web or sheet-like material, specifically, a flexible glass substrate. The anti-reflective material of the invention may be provided as a web wound up on a roll or may be cut in sheets. When supplied as sheets, an interleaf is provided as a protective sheet or spacer between two consecutive anti-reflective sheets. When supplied as a roll, a web interleaf is wound up on the roll together with the anti-reflective material. However, the interleaf material is in direct contact with the support, which could result in blocking of any coated layers and damage to the coatings on adjacent laps due to pressure sensitivity. Also, the interleaf material does not provide a method to allow for airflow through the roll for humidity preconditioning or the escape of gas or gaseous by-products from the curing of other coatings on the support.

US 2003/0205314 describes a process to extrude plastics. The surface of a film is embossed with a finish, is cooled, and the cooled thermoplastic sheet is collected on a roll or cut using a single layer of interleaf material to separate consecutive wraps or layers. However, the interleaf material is in direct contact with the support, which may result in the blocking of any coated layers and pressure between adjacent laps, resulting in damage to the coatings themselves. Also, the interleaf material does not provide a method for humidity preconditioning or the escape of any gas or gaseous by-products from the curing of any coated layers once the roll has been wound.

### PROBLEM TO BE SOLVED

There remains a need to provide a method of manufacturing, which will avoid humidity-related dimensional change in the support.

### SUMMARY OF THE INVENTION

The present invention relates to a method of conditioning a support comprising continuously providing a support, applying an interleaving material to at least one side of the support, wherein the interleaving material produces a continuous gap between the opposite side of the support having applied interleaving material and the side of the support having applied interleaving material when the support is wound, and conditioning the support.

### ADVANTAGEOUS EFFECT OF THE INVENTION

The present invention includes several advantages, not all of which are incorporated in a single embodiment. The new concept provides strips of permeable material wound into the roll at each edge of the web. These strips are of a height and width and wound at a tension such that the present invention provides continuous, potentially uniform interlayer gaps radially and axially through a wound roll. The interleaving provides a channel for air and water vapor to flow through freely between the gap created between the face side, that is, the side of the support to which subsequent coatings, preferably imaging layers, are applied, and the back side, that is, the side of the support opposite the primary functional coated layers, of subsequent laps of a flexible support and any coatings or printed material on the support and prohibiting any interlayer contact, so that equilibration to moisture or temperature can proceed while the support is still in a roll format and thus subsequent operations can be roll-to-roll, also referred to as continuous, in nature. Conditioning flexible supports to moisture is particularly advantageous in preventing large dimensional changes due to take up of moisture by the polymeric flexible supports. The flexible polymeric support as manufactured has essentially no internal moisture and will remain that way in roll format. The present invention is particularly valuable in providing a method to precondition the bone-dry support, with or without ITO, to humidity prior to any coating or printing processing steps since the vast majority of any dimensional change due to a change in internal moisture content will occur prior to a series of steps where precision alignment is critical.

### BRIEF DESCRIPTION OF THE DRAWINGS

FIG. 1 is a cross sectional view, not to scale, of the wound support, coating on the support and the interleaving material. This view represents the interaction of the support, its coatings and the interleaving.

FIG. 2 is a possible test setup, not to scale, which may be used to investigate the feasibility of this invention.

FIG. 3 is a schematic of the process flow of the manufacturing of coated support.

FIG. 4 is a representation, not to scale, of the mesh used as an interleaving material.

FIG. 5 is a plot showing the weight gain or loss from an interleaved roll and a tightly wound roll.

FIG. 6 is a plot showing the rate of weight gained for an interleaved roll through natural diffusion through the porous edge interleaving material.

### DETAILED DESCRIPTION OF THE INVENTION

The present invention relates to a method of conditioning, also referred to herein as preconditioning, a roll of flexible polymeric support to humidity or temperature, allowing most of the resulting dimensional change in the support to occur prior to subsequent downstream operations requiring precision alignment. The present invention accomplishes this by winding a permeable strip interleaving material into each edge of the support so as not to be in contact with any coated, printed, sprayed or other material applied to the support or which may be later applied to the support, and winding the support to produce a uniform or at least continuous gap between the opposite sides of the support, for example, the face side and back side of the support. The interleaving material provides a continuous gap to enable conditioning of the support prior to or at the same time as the application of functional layers on the support, as well as complete curing of the printed material, pressure relief in the wound roll, and which minimizes any waste that may occur due to pressure damage and blocking. The present invention is particularly useful in continuous or roll-to-roll manufacture of displays articles.

The goal of the interleaving is to provide a continuous gap in between all adjacent laps in a wound roll. This is done for two primary reasons. The interleaving allows air to be blown through the wound roll freely or allows natural flow of air or gases. This is a desirable feature for conditioning the support, which may also mitigate the effects of blocking of applied functional layers, a molecular transfer between adjacent layers in very intimate contact. Secondly, the interleaving relieves pressure on the interleaved support. For purposes of the present invention, a gap is considered continuous if lapped layers of the support are not in direct and intimate contact with each other and the gap is sufficient to allow contact with surrounding conditions, such as in-flow and out-flow of with air or other gas.

Interleaving has been developed that provides a continuous gap between adjacent laps in a wound roll that provides in-roll venting. The interleaving provides a channel for air to pass freely either by forcing air through or natural air flow. This interleaving also provides support for lap separation in the roll. The interleaving material is reusable and clean. This technology may be practical for new products that need separation of laps in roll-to-roll manufacturing.

Various materials may be used as interleaving materials. The interleaving material provides a channel for air to pass freely through. Preferably, the interleaving material is in the form of a continuous roll and is continuously applied to the support. The applied interleaving material may also be removed from the support, once the interleaved roll is unwound, thereby facilitating reuse. The interleaving material may have a variety of configurations. In one preferred embodiment, the interleaving material has a width that is less than or equal to the distance from the edge of the support to any coated, printed, sprayed or otherwise added material. Preferably, at least two rolls of interleaving material are used to support each edge of the wound roll, but one roll may be used along only one edge of the support or on the support in a location other than an edge, but not in contact with any applied coatings, provided that the support is stiff enough to maintain the gap created by the interleaved material without sagging on the unsupported edge.

The interleaving material is most desirably a flexible material and a permeable material. The interleaving material may be made of natural fibers, synthetic fibers, extruded synthetic materials, metals and the like. The interleaving material may be a textile produced from natural fibers. Porous foam may be used as interleaving material. The porosity of open-cell foam may allow air to be blown between layers. The foam may provide a continuous support throughout the roll and there is no pattern in this material to allow adjacent laps to come into phase and mesh together. In one embodiment, two strips of thin porous foam may be interleaved into the wound roll.

Bubble wrap may also be used as interleaving material. This product is a cheap, readily available solution to providing support in an interleaved roll. There are gaps in between the air pockets, which allow air to be blown through. The outside layers are thin sheets of plastic with the middle layer containing the actual bubbles.

Velcro® fastener material may also be used as interleaving material. The hook component of Velcro® fastener material provides a continual separator and cushion for the support and also allows air flow through it without a significant pressure drop across the strips. The Velcro® fastener material has enough stiffness that the hooks are not crushed under pressure. This is a desirable feature as the rolls are wound. Higher winding tensions generally lead to higher in-roll pressure. Since the Velcro® fastener material minimally compresses, higher winding tensions may be used to wind the roll, resulting in a tighter wound roll.

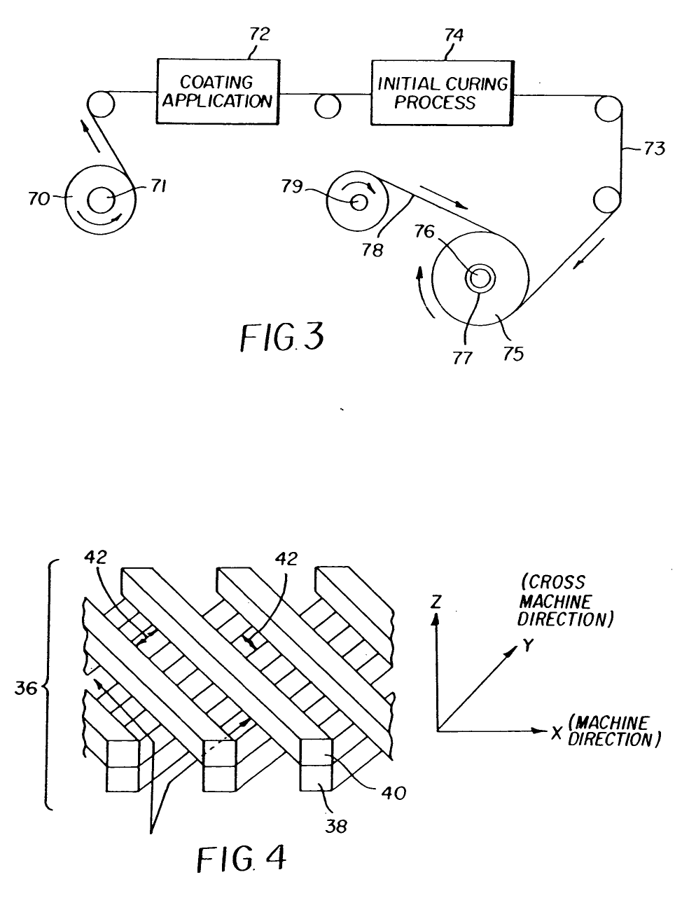

Mesh materials may also be used to interleave the support. Plastic mesh materials are of particular interest. The mesh may be an extruded plastic and bi-planar in nature, as shown in FIG. 4. In one embodiment, strips of polymer mesh are interleaved onto the edges of a roll. Bi-planar refers to any mesh that, when manufactured, forms channels that may be used to allow gas or liquid flow. Typically, the mesh is two extruded layers of polymer, which has cross-member layers of polymer, which are not in the same x-y plane. As shown in FIG. 4, member 38 and cross-member 40, when combined, form a polymeric mesh material 36 having channels 42 to allow flow. The bi-planar nature of the mesh will allow air to be blown through a roll. In a preferred embodiment, the mesh may be slit down to strips and wound into the roll, as with the Velcro® fastener interleaving. Types of mesh material suitable for use in the invention are polypropylene meshes, such as XN-4510, at 96 lbs/1000 ft², and XN-4410, at 40 lbs/1000 ft², made by InterNet Incorporated, Minneapolis, Minn. Various types of mesh configurations are available. Mesh that is commercially available can have a wide range of thickness. The mesh may be thick enough that it can withstand distortions caused by winding tensions at which it will be conveyed. However, the thicker the mesh, the larger the wound roll produced, which is harder to deal with in a production setting. As the thickness of the material will play a significant role in the size of the wound roll, the appropriate thickness for the interleaving materials is preferably determined, based on the final end use and manufacturing requirements.

Various types of interleaving configurations are available. Interleaving material is commercially available in a wide range of thicknesses. The interleaving material may be of any thickness, which allows the formation of a continuous gap in a wound roll. The interleaving material desirably produces a continuous gap of greater than 75 microns, more preferably from 0.127 mm to 3.175 mm (5 mils to 500 mils). Preferably the gap is sufficient to allow an air flow, created by pumping air through the gap, of from greater than 0 to 269 mpm (0 to 880 fpm) in velocity. The preferred range of thickness for the interleaving material for use in liquid crystalline display production is in the range of 0.762 mm to 2.286 mm (30-90 mils), such as Velcro® fastener material at approximately 1.524 (60 mils) in thickness, and plastic mesh interleaving material at approximately 1.016 mm to 2.032 mm (40 mils or 80 mils) in thickness.

The interleaving material may include an adhesive backing. The adhesive is advantageous to enhance and speed up different winding conditions, primarily winding tension. Unwinding and winding may be simplified, since the interleaving material becomes one with the support. In one embodiment, the interleaving material may be adhered to a second support, which, when in use, is in contact with the backside or uncoated side of the printed support.

In simplest form, the interleaving material is interleaved with a windable support. Preferably, the winding process is continuous. The support may be made of a flexible material, preferably a flexible polymeric material such as Kodak Estar film base formed of polyester plastic. Preferably, the thickness of the support is at least 3 microns, and more preferably, from 50 to 250 microns or approximately 2-10 mils. For example, the support may be an 80 microns thick sheet of transparent polyester. The thickness of the support and curable material layers may vary but are most preferably in the range from 60 to 300 microns, with the thickness of the curable layers in the range of from 10 to 70 microns.

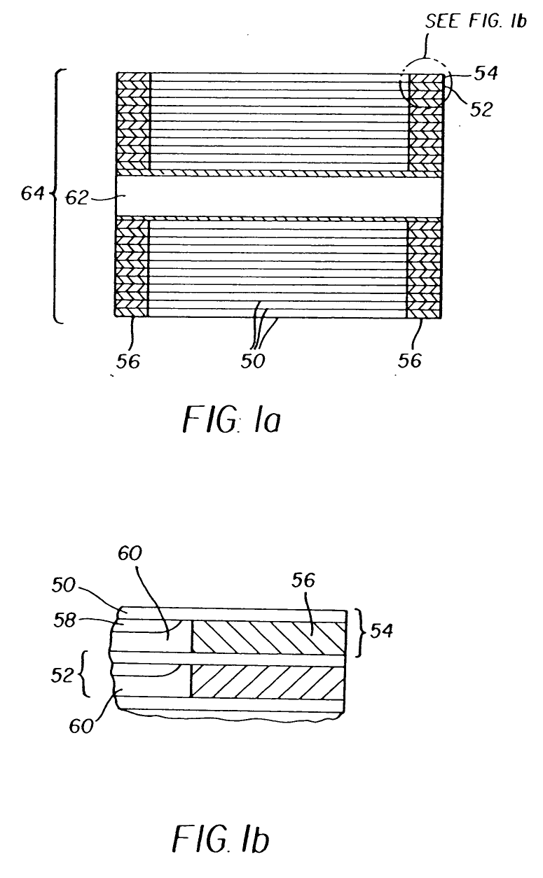

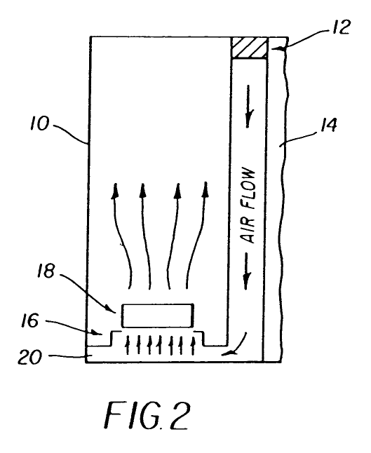

A preferred embodiment of a wound roll according to the invention is illustrated in FIG. 1a as a lengthwise cross sectional view of an exemplary wound roll. A windable support 50 is wound on a core 62. Interleaving material 56 is applied to support 50, prior to winding. The support, optionally coated, is then wound to form wound roll 64, containing multiple consecutive laps, such as lap 1 (52) and lap 2 (54). A gap 60 is produced by interleaving material 56, which keeps the back side and front side of the windable support 50 from contacting each other in subsequent laps in the roll. The resulting gap 60 provides for air to get to the front side and back side of the support for moisture or temperature equilibration or for other purposes such as curing. The support may be conditioned prior to being wound, prior to the application of coatings onto the support. The support may also be conditioned in roll form, that is, after winding.

In another distinguished embodiment, a material 60 is applied to the support by any method known by those of skill in the art to form a layer. Some exemplary methods may include screen-printing, hopper coating, gravure printing, lithographic and photolithographic printing, spraying, and vapor depositing and is subsequently wound with the porous strip interleaving material. The resulting gap prevents the applied material 60 to contact the backside of the support 50 on the next lap in the roll. This is an especially useful feature when the material 60 is applied to ITO on the support and is prevented from contacting the support directly on the next lap. Without this intimate contact, the rate of moisture transfer from the applied material 60 to the support 50 is greatly diminished, as ITO is an effective barrier.

The support may be any support which is subject to dimensional changes as a result of exposure to the environment, for example environmental heat and humidity as well as processing environmental conditions of heat and humidity. The dimensional changes in the appropriate supports for the present use would adversely affect any materials applied to the support. For example, dimensional changes in the support bearing a coated layer would adversely affect the ability to properly align later coatings with previous coated features applied to the support. Also, dimensional changes could adversely affect printing directly on the support or on layers on the support.

Preferably, the support is a flexible support. The flexible plastic support may be any flexible self-supporting plastic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film preferably has sufficient thickness and mechanical integrity so as to be self-supporting, yet may not be so thick as to be rigid. Typically, the flexible plastic support is the thickest layer of a composite film in thickness. Consequently, the support determines to a large extent the mechanical and thermal stability of the fully structured composite film.

Another significant characteristic of a flexible plastic support material is its glass transition temperature (Tg). Tg is defined as the glass transition temperature at which plastic material will change from the glassy state to the rubbery state. It comprises a range before the material may actually flow. Suitable materials for the flexible plastic support include thermoplastics of a relatively low glass transition temperature, for example up to 150° C., as well as materials of a higher glass transition temperature, for example, above 150° C. The choice of material for the flexible plastic support may depend on various factors, for example, manufacturing process conditions, such as deposition temperature, and annealing temperature, as well as those conditions encountered post-manufacturing, such as in a process line of a display manufacturer. Certain of the plastic supports discussed below can withstand higher processing temperatures of up to at least 200° C., some up to 300-350° C., without damage.

Typically, the flexible plastic support is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic support is a cyclic polyolefin or a polyester. Various cyclic polyolefins are suitable for the flexible plastic support. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton® is a poly(bis(cyclopentadiene)) condensate that is a film of a polymer. A preferred polyester is an aromatic polyester such as Arylite. Although various examples of plastic supports are set forth above, it may be appreciated that the support may also be formed from other materials such as glass and quartz, providing they are flexible.

The flexible plastic support may be reinforced with a hard coating. Typically, the hard coating is an acrylic coating. Such a hard coating typically has a thickness of from 1 to 15 microns, preferably from 2 to 4 microns and may be provided by free radical polymerization, initiated either thermally or by ultraviolet radiation, of an appropriate polymerizable material. Depending on the support, different hard coatings may be used. When the support is polyester or Arton®, a particularly preferred hard coating is the coating known as “Lintec.” Lintec contains UV-cured polyester acrylate and colloidal silica. When deposited on Arton®, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

Once the interleaving and coated support have been wound into a roll, various process steps may be taken while in this format. The wound roll package may be shipped in this state. The interlayer pressure, between laps in the roll, allows the wound roll package to remain intact and not lose integrity or fall apart. The wound roll package may be unwound at a post-processing station for any variety of process steps. This wound roll package allows for easy handling, shipping, storage, while not destroying the coatings or scratching the coated surfaces and at the same time allowing for post processing curing to occur.

In simplest form, the method as depicted in FIG. 3 provides unwinding of the support 70 by the unwinder 71, interleaving application 78 and winding 76 of the support. The interleaved roll of support can then be conditioned to humidity or temperature, followed by unwinding and removal of the interleave material. Conditioning may occur through exposing the support to environmental air, such as process air, having a relative humidity at which time the moisture content of the support will equilibrate with the relative humidity of the air. Conditioning may also occur by blowing air having a relative humidity through the gap in the roll produced by the interleaving and allowing the moisture content of the support to equilibrate with the relative humidity of the air. Thermal conditionaling may be accomplished in the same manner, that is, by passive exposure or active exposure, for example, blowing of heated air or fluid.

An exemplary process design is also illustrated in FIG. 3, which includes a deposition step which could be of any method but for illustrative purposes is shown as coating 72 and a curing step 72. The uncoated support 70 is unwound by unwinder 71 and conveyed to a station where the coating application 72 occurs. Once coated, the support is conveyed to a cure initiation station 74, at which point curing begins. However, curing is completed in the wound roll. The coated support 73 is then conveyed to the winder 76, where the interleaving material 78 is unwound by secondary unwinder 79 and applied at the same time that the support is wound onto a core 77. The coated, wound roll 75 may then be subjected to other process steps such as curing or conditioning, further winding or rewinding, shipping, handling, or any other suitable process steps.

The interleaving material may be applied to the support before, during or after the applications of any coatings to the support. In addition, the interleaving material may be applied to both sides of the roll, that is, applied to the coated side of the support, as well as the side of the support opposite the coated side. In some instances, both sides of the support may be coated. It is intended that this method will be applicable to any width of support. However when the support is very wide, at least a third strip of interleaving may be needed to provide support in the center of the roll. This is needed when the stiffness of the web is insufficient to carry the load caused by the weight of the support across the width.

The rolls may be wound at various winding tensions. Winding the support and interleaving at too high a tension may cause the interleaving to be crushed and inadvertently minimize the gap, which the interleaving is intended to create. Contrarily, when the coated support and the interleaving are not wound at high enough tensions, the produced wound roll may not have enough integrity to remain in a roll form and could clock spring, telescope or dish, common roll winding defects. The interleaving material provides support around the roll in the radial and axial direction. Tension ranges for winding may vary depending on the usage of the coated support and the interleaving embodiment selected. The interleaving material is desirably capable of being wound at the same tension as the support material. For example, if a spiral interleaving format is selected, the tension may be anything greater than 0. If a Velcro® interleaving material is selected, typical tension ranges may vary from 17.5 to 1752 Newtons per linear meter (0.1 to 10 pounds per linear inch) and winding speed may vary from 0.03 to 152 meters per minute (0.1 to 500 feet per minute).

In one embodiment, a conditioned support bearing a conductive layer is used in a flat panel display used in various electronic devices. At a minimum, the display comprises a substrate, at least one conductive layer an electrically modulated imaging layer. In a preferred embodiment, the conductive layer is ITO and the imaging layer is a liquid crystalline material. The display may also comprise two sheets of polarizing material with an electrically modulated imaging solution between the polarizing sheets. The sheets of polarizing material may be a substrate of glass or transparent plastic. The display may also include functional layers. In one embodiment, a transparent, multilayer flexible support is coated with a first conductive layer, which may be patterned, onto which is coated an electrically modulated imaging layer. A second conductive layer is applied and overcoated with a functional layer. Dielectric conductive row contacts are attached, including via holes that permit interconnection between the conductive layers and the dielectric conductive row contacts. In a typical matrix-address light-emitting display device, numerous light-emitting devices are formed on a single substrate and arranged in groups in a regular grid pattern. Activation may be by rows and columns, or in an active matrix with individual cathode and anode paths.

The display includes a suitable electrically modulated material disposed on a suitable support structure, such as on or between one or more electrodes. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. The electrically imageable material can be addressed with an electric field and then retain its image after the electric field is removed, a property typically referred to as “bistable”. The electrically modulated material may be electrochromic material, electrochemical, electrophoretic, such as Gyricon particles, rotatable microencapsulated microspheres, liquid crystal materials, cholesteric/chiral nematic liquid crystal materials, polymer dispersed liquid crystals (PDLC), polymer stabilized liquid crystals, surface stabilized liquid crystals, smectic liquid crystals, ferroelectric material, electroluminescent material or any other of a very large number of light modulating imaging materials known in the prior art. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple support layers, however, are optional for providing additional advantages in some case.

The liquid crystal (LC) is used as an optical switch. The supports are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

Liquid crystals may be nematic (N), chiral nematic (N*), or smectic, depending upon the arrangement of the molecules in the mesophase. In the preferred embodiment, the electrically modulated material is a chiral nematic liquid crystal incorporated in a polymer matrix. Chiral nematic liquid crystalline materials may be used to create electronic displays that are both bistable and viewable under ambient lighting. Furthermore, the liquid crystalline materials may be dispersed as micron sized droplets in an aqueous medium, mixed with a suitable binder material and coated on a flexible conductive support to create potentially low cost displays. The operation of these displays is dependent on the contrast between the planar reflecting state and the weakly scattering focal conic state.

Chiral nematic liquid crystal refers to the type of liquid crystal having finer pitch than that of twisted nematic and super-twisted nematic. Chiral nematic liquid crystals are so named because such liquid crystal formulations are commonly obtained by adding chiral agents to host nematic liquid crystals. Chiral nematic liquid crystals may be used to provide bistable and multistable reflective displays that, due to their non-volatile “memory” characteristic, do not require a continuous driving circuit to maintain a display image, thereby significantly reducing power consumption. Chiral nematic displays are bistable in the absence of a field, the two stable textures being the reflective planar texture and the weakly scattering focal conic texture. In the planar texture, the helical axes of the chiral nematic liquid crystal molecules are substantially parallel to the support upon which the liquid crystal is disposed. In the focal conic, state the helical axes of the liquid crystal molecules are generally randomly oriented. By adjusting the concentration of chiral dopants in the chiral nematic material, the pitch length of the molecules and, thus, the wavelength of radiation that they will reflect, may be adjusted. Chiral nematic materials that reflect infrared radiation have been used for purposes of scientific study. Commercial displays are most often fabricated from chiral nematic materials that reflect visible light. Some known LCD devices include chemically-etched, transparent, conductive layers overlying a glass substrate as described in U.S. Pat. No. 5,667,853, incorporated herein by reference. The present invention may employ, as a light-modulating layer, chiral-nematic liquid-crystal compositions dispersed in a continuous matrix. Such materials are referred to as “polymer-dispersed liquid crystal” materials or “PDLC” materials.

Modern chiral nematic liquid crystal materials usually include at least one nematic host combined with a chiral dopant. Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bistability and gray scale memory. The chiral nematic liquid crystal is typically a mixture of nematic liquid crystal and chiral material in an amount sufficient to produce the desired pitch length.

Chiral nematic liquid crystal materials and cells, as well as polymer stabilized chiral nematic liquid crystals and cells, are well known in the art and described in, for example, U.S. Pat. No. 5,695,682, U.S. application Ser. No. 07/969,093, Ser. No. 08/057,662, Yang et al., Appl. Phys. Lett. 60(25) pp 3102-04 (1992), Yang et al., J. Appl. Phys. 76(2) pp 1331 (1994), published International Patent Application No. PCT/US92/09367, and published International Patent Application No. PCT/US92/03504, all of which are incorporated herein by reference.

The liquid crystalline layer or layers may also contain other ingredients. For example, while color is introduced by the liquid crystal material itself, pleochroic dyes may be added to intensify or vary the color reflected by the cell. Similarly, additives such as fumed silica may be dissolved in the liquid crystal mixture to adjust the stability of the various chiral nematic textures. A dye in an amount ranging from about 0.25% to about 1.5% may also be used.

At least one curable conductive layer is present in display devices. A first conductor is formed over substrate. The first conductor can be a transparent, electrically conductive layer of tin-oxide or indium-tin-oxide (ITO), with ITO being the preferred material. Alternatively, first conductor can be an opaque electrical conductor formed of metal such as copper, aluminum or nickel. If first conductor is an opaque metal, the metal can be a metal oxide to create a light absorbing first conductor. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃.

The conductive layer may be formed, for example, by a low temperature sputtering technique or by a direct current sputtering technique, such as DC sputtering or RF-DC sputtering, depending upon the material or materials of the underlying layer. Typically, the conductive layer is sputtered onto the substrate to a resistance of less than 250 ohms per square.

A second conductor may be applied to the surface of light modulating imaging layer. The second conductor should have sufficient conductivity to carry a field across light modulating imaging layer. The second conductive layer may comprise any of the electrically conductive materials discussed for use in the first transparent conductive layer. However, the second conductive layer need not be transparent. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin oxide or indium tin oxide, resulting in the layer being transparent. Alternatively, second conductive layer may be printed conductive ink. For higher conductivities, the conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd).

The LCD may also comprise functional layers, including a conductive layer between the curable layers and the support and any of the layers described above as curable layers. One type of functional layer may be a color contrast layer. The functional layer may comprise a protective layer or a barrier layer. In another embodiment, the polymeric support may further comprise an antistatic layer to manage unwanted charge build up on the sheet or web during roll conveyance or sheet finishing. The functional layer may also comprise a dielectric material. A dielectric layer, for purposes of the present invention, is a layer that is not conductive or blocks the flow of electricity.

In addition to displays, the present invention may be utilized in other applications. For example, another possible application is polymer films with a chiral liquid crystalline phase for optical elements, such as chiral nematic broadband polarizers or chiral liquid crystalline retardation films. Among these are active and passive optical elements or color filters and liquid crystal displays, for example STN, TN, AMD-TN, temperature compensation, polymer free or polymer stabilized chiral nematic texture (PFCT, PSCT) displays. Possible display industry applications include ultralight, flexible, and inexpensive displays for notebook and desktop computers, instrument panels, video game machines, videophones, mobile phones, hand-held PCs, PDAs, e-books, camcorders, satellite navigation systems, store and supermarket pricing systems, highway signs, informational displays, smart cards, toys, and other electronic devices. The present invention may also be used in the production of other products, for example, sensors, medical test films, solar cells, fuel cells, to name a few.

### EXAMPLES

The following examples are provided to illustrate the invention.

Two identical 200 linear foot by 15 inch wide rolls of 5.2 mil polyester with a gelatin coating were obtained. The gelatin coating was chosen since it readily absorbs moisture from air. One roll was left tightly wound. The other roll was interleaved with permeable mesh (Vexar®) strips on each edge.

After conditioning a wound roll at a specific temperature and relative humidity for 24 hours, each roll was weighed. Then each roll was moved to a walk-in environmental chamber at a different relative humidity. Conditioning was by natural diffusion through the porous interleaving end strips. After 24-hours at this new relative humidity each roll was weighed again. This procedure was repeated for all relative humidities outlined in the experiment.

Along with the two rolls, a Mettler Model PE24 Electronic Balance

| Run | Walk-in Chamber | Walk-in Chamber |
|---|---|---|
| Order | Relative Humidity | Temperature |
| 1 | 50% | 73 deg F. |
| 2 | 20% | 73 deg F. |
| 3 | 70% | 73 deg F. |
| 4 | 5% | 73 deg F. |
| 5 | 50% | 73 deg F. |
| 6 | 85% | 73 deg F. |
| 7 | 20% | 73 deg F. |
| 8 | 50% | 73 deg F. |

was moved from walk-in chamber to walk-in chamber, to measure the rolls after 24 hours of conditioning. In addition, several other items were conditioned and measured: a stainless steel bar weighing 2963 grams, two plastic cores weighing approximately 2200 grams each, and a stock roll of the plastic interleaving material weighing 3917 grams.

The plastic cores were the same material as used for the roll cores in winding the support coated with gelatin. The cores and the interleave stock roll did not change weight as they traveled with the rolls and were weighed after 24 hours. This proves that the cores and the interleave material did not absorb moisture from the air and any roll weight changes are due to moisture absorption by the gelatin coating PET support.

The stainless steel bar also did not change weight throughout the experiment, verifying that the Mettler Electronic Balance remained in calibration, as the electronic balance traveled from room to room.

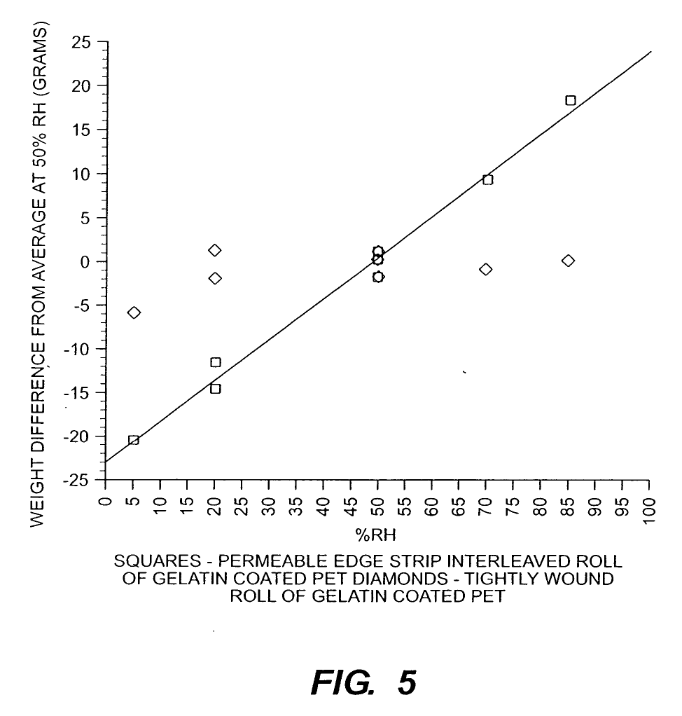

FIG. 5 shows the bivariate Fit of 24 Hour Weight Difference from 50% RH (grams) by % RH for the interleaved and tightly wound roll when the weight gain or loss is normalized to 50% relative humidity. As can be seen there is essentially no change in weight in the tightly wound roll whereas, the roll with permeable strip interleaving changes weight easily. This weight gain or loss is directly proportional to the relative humidity difference between the conditioning relative humidity and the reference humidity of 50%.

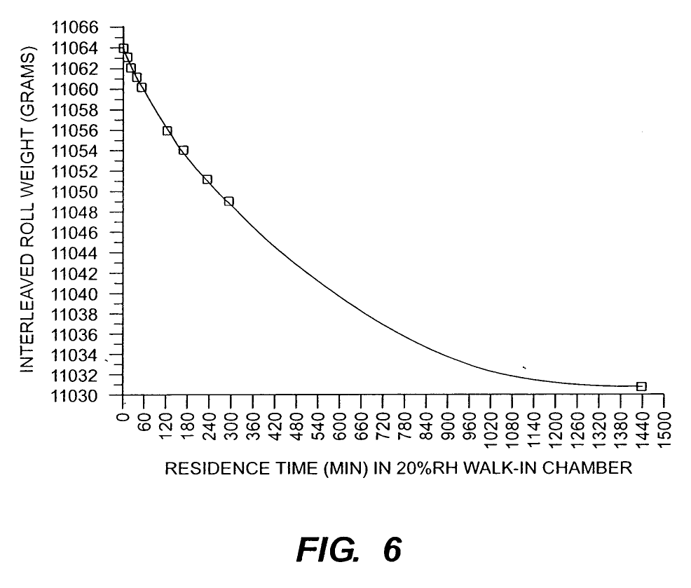

FIG. 6 shows the bivariate fit of black interleaved by residence time (minutes), that is, the rate of weight gain. As would be expected weight gain from moisture takeup is rapid and falls off as equilibrium is achieved. The rate of moisture takeup is more rapid with a gelatin coating than would occur with only PET but the mechanism would be the same with only the time of equilibrium being somewhat longer. The rate could be dramatically increased by pushing conditioned air through the roll through the permeable strip interleaved material.

The comparison between the two rolls (tightly wound or interleaved) demonstrates that interleaving allows much faster equilibration of wound rolls to local environmental conditions.

The invention has been described in detail with particular reference to certain preferred embodiments thereof, but it will be understood that variations and modifications can be effected within the spirit and scope of the invention.

1. A method of conditioning a support comprising continuously providing a support, applying an interleaving material to at least one side of said support, wherein said interleaving material produces a continuous gap between the opposite side of said support having applied interleaving material and the side of said support having applied interleaving material when said support is wound, and conditioning said support.

2. The method of conditioning a support of claim 1 further comprising winding said support.

3. The method of conditioning a support of claim 1 wherein said winding is continuous.

4. The method of conditioning a support of claim 2 wherein said conditioning is before said winding.

5. The method of conditioning a support of claim 2 wherein said conditioning is after said winding.

6. The method of conditioning a support of claim 1 wherein said support is a flexible polymeric support.

7. The method of conditioning a support of claim 1 wherein said support comprises a flexible support.

8. The method of conditioning a support of claim 1 wherein said support comprises polyethylene terephthalate (PET).

9. The method of conditioning a support of claim 1 wherein said support has been previously wound onto a core.

10. The method of conditioning a support of claim 1 wherein said interleaving material is a permeable strip interleaving material

11. The method of conditioning a support of claim 1 wherein said interleaving material comprises a continuous roll.

12. The method of conditioning a support of claim 1 wherein said interleaving material comprises a strip applied along at least one edge of said support.

13. The method of conditioning a support of claim 1 wherein said interleaving material comprises a strip applied along at least two edges of said support.

14. The method of conditioning a support of claim 1 wherein said interleaving material comprises of a flexible material.

15. The method of conditioning a support of claim 14 wherein said flexible material comprises open celled foam.

16. The method of conditioning a support of claim 14 wherein said flexible material comprises Velcro® fastener material.

17. The method of conditioning a support of claim 14 wherein said flexible material comprises mesh.

18. The method of conditioning a support of claim 1 wherein said interleaving material further comprises adhesive backing.

19. The method of conditioning a support of conditioning a support of claim 1 wherein said conditioning is with respect to moisture.

20. The method of conditioning a support of claim 19 wherein said conditioning with respect to moisture comprises exposing said support to air having a relative humidity and allowing the moisture content of said support to equilibrate with the relative humidity of said air.

21. The method of conditioning a support of claim 19 wherein said conditioning with respect to moisture comprises blowing air having a relative humidity through said gap and allowing the moisture content of said support to equilibrate with the relative humidity of said air.

22. The method of conditioning a support of claim 1 wherein said conditioning is with respect to temperature.

23. The method of conditioning a support of claim 1 further comprising applying at least one coating.

24. The method of conditioning a support of claim 23 wherein said coating is an ITO coating.

25. The method of conditioning a support of claim 24 further comprising applying at least one liquid crystalline imaging layer to said ITO coating.

26. The method of conditioning a support of claim 23 wherein said coating is applied before said winding and after said conditioning.
